(19) United States
(12) Patent Application Publication
(10) Pub. No.: US 2009/0316215 A1
(43) Pub. Date: Dec. 24, 2009

(54) IMAGE FORMING APPARATUS, MANAGEMENT SYSTEM AND MANAGEMENT METHOD

(76) Inventor: Koji KITA, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/330,979

(22) Filed: Dec. 9, 2008

(30) Foreign Application Priority Data
Jun. 20, 2008 (JP) 2008-161136

(51) Int. Cl. G06K 15/00; G06K 1/00

(52) U.S. Cl. 358/3.28; 358/1.9; 358/1.15

(57) ABSTRACT

Disclosed is an image forming apparatus including: an output section; a counter to count operation record information; a clock section to keep time for date and time information; and a control section to obtain a counter value of operation record information counted by the counter, to obtain by the clock section date and time information of when the counter value is obtained, to generate code information including the counter value and the date and time information, to convert the code information to an image code, and to output the image code to the output section.

### BACKGROUND

1. Field of the Invention

The present invention relates to an image forming apparatus, management system and management method.

2. Description of Related Art

Lately, there is a system where an image forming apparatus outputs its status information externally and a management server which receives the status information analyzes the image forming apparatus so that maintenance management of the image forming apparatus is performed.

For example, Japanese Patent Application Laid-Open Publication No. 2007-110524 discloses a system to use a digital camera integrated in a cellular phone unit to photograph a character or a two-dimensional code (for example, QR code) showing character information such as URL, e-mail address, phone number, etc., to connect to internet using the information obtained by the photography to support maintenance of an information apparatus.

Also, Japanese Patent Application Laid-Open Publication No. 2007-235873 discloses an information processing system which converts error information including alarm condition information and contact information for notifying the alarm condition into two-dimensional code, displays the two-dimensional code and sends the information of the alarm condition read from the two-dimensional code to a contact according to the contact information.

However, in a system which sends above-described status information with character, two-dimensional code, etc. to the management server to perform maintenance management, information showing when the status information occurred is not included in the status information received by the management server.

Therefore, when operation record information (for example, counter value of number of sheets on which image is formed, number of sheets ejected, etc. counted from a pre-set time period) of the image forming apparatus is sent as status information, date and time of when the counter value is generated is unclear. Thus, time-oriented relation between a received counter value and a counter value received before and after the received counter value is unclear to the management server. Therefore, for example, in a system which charges based on the counter value, trouble such as calculation mistake of charged fee occur or in a system which performs maintenance based on the counter value, time period of maintenance may be shifted and cause a problem in the apparatus.

### SUMMARY

The present invention has been made in consideration of the above problems, and it is one of main objects to enhance reliability of counter value.

In order to achieve at least one of the above-described objects, according to an aspect of the present invention, there is provided an image forming apparatus, comprising:

an output section;

a counter to count operation record information;

a clock section to keep time for date and time information; and

a control section to obtain a counter value of operation record information counted by the counter, to obtain by the clock section date and time information of when the counter value is obtained, to generate code information including the counter value and the date and time information, to convert the code information to an image code, and to output the image code to the output section.

According to another aspect of the present invention, there is provided a management system of an image forming apparatus comprising:

an image forming apparatus; and

a terminal apparatus to send information concerning the image forming apparatus to a management server, wherein

the image forming apparatus comprises:

an output section;

a counter to count operation record information;

a clock section to keep time for date and time information; and

a control section to obtain a counter value of the operation record information counted by the counter, to obtain by the clock section the date and time information of when the counter value is obtained, to generate code information including the counter value and the date and time information, to convert the code information to an image code, and to output the image code to the output section, and

the terminal apparatus comprises:

a communication section to perform communication with the management server;

an image code reading section to read the image code; and

a sending control section to obtain the code information based on the image code read by the image code reading section to send the code information through the communication section to the management server.

According to another aspect of the present invention, there is provided a management method of sending information of an image forming apparatus to a management server, the method comprising:

obtaining a counter value counted by a counter which counts operation record information of the image forming apparatus;

obtaining by a clock section date and time information of when the counter value is obtained;

generating code information including the counter value and the date and time information of when the counter value is obtained;

converting the code information to an image code;

outputting the image code to the output section;

reading the image code output from the output section;

obtaining the code information based on the read image code; and

sending the code information through a communication section to the management server.

### BRIEF DESCRIPTION OF THE DRAWINGS

The present invention will become more fully understood from the detailed description given hereinbelow and the appended drawings, and thus are not intended to define the limits of the present invention, and wherein;

FIG. 1 is a configuration diagram showing a management system;

FIG. 2 is a control block diagram showing an image forming apparatus;

FIG. 3 is a control block diagram showing a terminal apparatus;

FIG. 4 is a flowchart showing an image code generating processing;

FIG. 5 is a flowchart showing the image code generating processing (continuation of FIG. 4);

FIG. 6 is a diagram showing an example of a code information setting screen;

FIG. 7 is a diagram showing an example of a sheet output from a print section 40 in step S22;

FIG. 8 is a diagram showing an example of a screen displayed on an operation/display section 20 in step S23; and

FIG. 9 is a flowchart showing image code sending processing.

### DETAILED DESCRIPTION OF PREFERRED EMBODIMENTS

A preferred embodiment reflecting an aspect of the present invention will be described in detail with reference to the drawings. However, the scope of the invention is not limited to the illustrated examples.

First, a structure will be described.

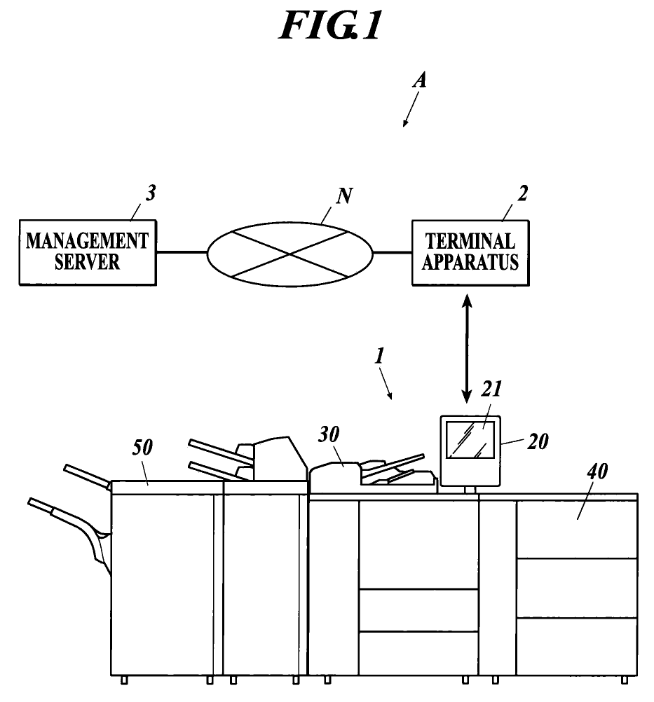

FIG. 1 is a configuration diagram showing a management system A of the preferred embodiment.

As shown in FIG. 1, the management system A is configured including, an image forming apparatus 1, terminal apparatus 2, and management server 3, and the terminal apparatus 2 and management server 3 are connected through a network N to enable communication connection. The management system A is a system which uses the terminal apparatus 2 to read an image code showing information of the image forming apparatus 1 and sends the code information based on the image code from the terminal apparatus 2 through the network N to the management server 3.

The image forming apparatus 1 is an apparatus for forming an image on a sheet such as a digital multi-function device, printer, FAX and the like to read an image from a document to form the read image on a sheet or an apparatus which includes a finisher section for performing finishing processing on a sheet with an image formed, or the like. The image forming apparatus 1 is comprised including an operation/display section 20, image reading section 30, print section 40, finisher section 50, and the like.

The terminal apparatus 2 is a portable terminal apparatus including a function for sending and receiving e-mail and WEB browsing, and includes a function of sending e-mail with the information obtained from the image forming apparatus 1 attached thereto or transferring the information to a web site. For example, a Personal Digital Assistance (PDA), cellular phone, Personal Handyphone System (PHS), mobile personal computer (PC) or the like can be used as the terminal apparatus 2. Also, the terminal apparatus 2 includes a reading section for reading a two-dimensional code such as a QR code or a barcode and sends the code information obtained by reading an image code with the reading section.

The management server 3 receives various counter values as operation record information of each image forming apparatus 1 sent from the terminal apparatus 2 through the network N and stores the counter values, and performs maintenance management of each image forming apparatus 1 according to the various counter values.

The network N is an internet network, public circuit network or the like. For example, the network N includes, various communication lines such as a telephone line network, ISDN line network, dedicated line, cellular communication network, communication satellite line, CATV line network or the like, and internet service provider base station for connecting these communication lines.

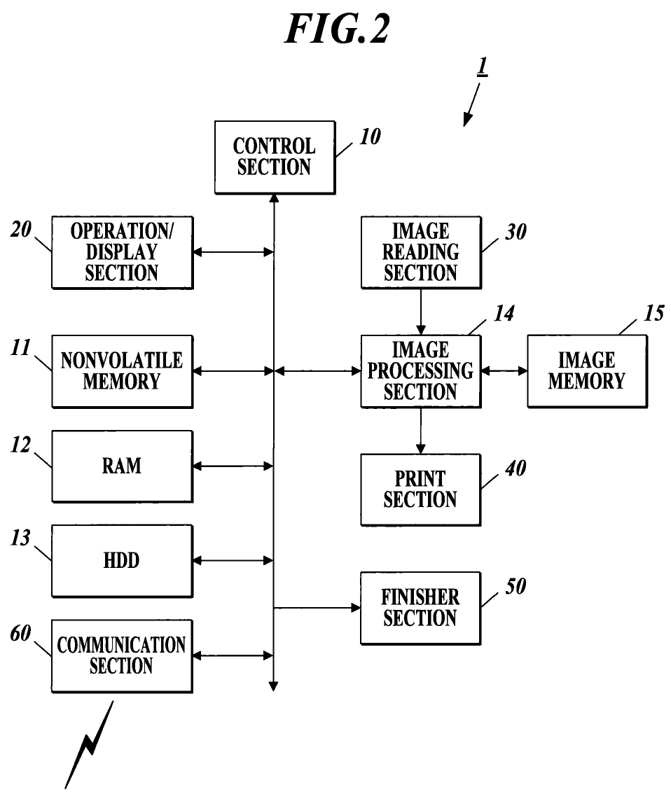

FIG. 2 shows a control block diagram showing the image forming apparatus 1.

As shown in FIG. 2, the image forming apparatus 1 is configured including a control section 10, nonvolatile memory 11, RAM 12, HDD 13, image processing section 14, image memory 15, operation/display section 20, image reading section 30, print section 40, finisher section 50, communication section 60 and the like.

The control section 10 includes a Central Processing Unit (CPU) and reads out a specified program from a system program and various application programs stored in the nonvolatile memory 11 to expand the program in the RAM 12, and in coordination with the program expanded in the RAM 12, the control section 10 performs various processing to centrally control each section of the image forming apparatus 1.

For example, according to an instruction signal input from the operation/display section 20, the control section 10 controls switching of copying mode, printer mode and scanner mode, copying, printing, reading of image data and the like.

The control section 10 includes a counter function. The counter function counts various counter values as operation record information of the image forming apparatus from a predetermined time. The various counter values are stored in the HDD 13.

The various counter values include, for example, fed sheet number count, ejected sheet number count, printer total count, copier total count, scanner total count, total count, etc. The fed sheet number count is a number of sheets fed from the sheet feeding tray in the print section 40. The ejected sheet number count is a number of sheets ejected from the print section 40 to the finisher section 50. The printer total count is a total number of sheet faces on which images are formed based on image data. The copier total count is a total number of sheet faces on which images are formed based on image data read by the image reading section 30. The scanner total count is a total number of pieces of image data read by the image reading section 30. The total count is a total number of these various counter values.

The control section 10 includes a function as a clock section to keep time for date and time information.

Date and time information is information showing present year, month, date, time, minute, second, etc.

The control section 10 obtains an image code generating processing program of the present embodiment from the nonvolatile memory 11 and in coordination with the program and various pieces of data, obtains various counter values stored in the HDD 13, generates code information including the various counter values and date and time information of when the various counter values were obtained from the HDD, and performs encoding processing on the code information according to setting information input from the operation/display section 20. The control section 10 converts the code information to a type of image code according to the setting information input from the operation/display section 20 and displays an image based on the image code on a display screen of the operation/display section 20 or performs processing of forming an image on a sheet based on the image code by the print section 40.

As a type of image code of the present embodiment there is a two-dimensional code such as QR code, PDF 417, Data Matrix, Maxi Code, etc., a barcode (for example, Code 39) and the like.

The nonvolatile memory 11 stores various processing programs and pieces of data concerning image forming and also the image code generating processing program according to the present embodiment, pieces of data from processing various programs and the like.

The RAM 12 forms a work area to temporarily store various programs performed by the control section 10 and various pieces of data concerning these programs and also stores setting information received by the operation/display section 20.

The HDD 13 stores various counter values counted by the control section 10. The storage section for storing the counter value is the HDD 13, however, it is not limited to this, and the nonvolatile memory 11 can store the counter value, or any other nonvolatile readable and writable storage medium can be used.

According to an instruction from the control section 10, the image processing section 14 compresses the image data input from the image reading section 30, writes the image data as compressed image data in a compression memory of the image memory 15 and temporarily stores the data. When there is an instruction to read the image data from the control section 10, the image processing section 14 extends the compressed image data stored in the image memory 15 and temporarily stores the data in the image memory 15. Then, when there is an instruction to form an image from the control section 10, the image processing section 14 reads out the uncompressed image data per page, performs image processing such as enlargement and reduction or change of direction and outputs the image data on which the image processing is performed to the print section 40.

The image memory 15 is configured with a Dynamic RAM (DRAM) and includes a compression memory for temporarily storing compressed image data and a page memory for temporarily storing uncompressed image data output to the print section 40 before image forming.

The operation/display section 20 includes a Liquid Crystal Display (LCD), a touch panel 21 provided so as to cover the LCD, various operation key groups such as a numeric keypad, and the like. According to a display signal input from the control section 10, the operation/display section 20 displays on the LCD various screens for inputting various setting conditions, various processing results, and the like. The operation/display section 20 outputs an operation signal input from various switches or buttons, numeric keypad, operation key group or touch panel 21 to the control section 10.

The image reading section 30 includes an automatic document feeding section called an Auto Document Feeder (ADF) and a reading section having a Charge Coupled Device (CCD) and reads images of a plurality of documents according to an instruction by the operation/display section 20. A document placed on a document tray of the automatic document feeding section is conveyed to a reading position on a contact glass where an image on one side or both sides of the document is read by an optical system and the image of the document is read by the CCD. Here, image is not limited to image data such as a figure, a photograph, etc., and includes text data and the like, such as a character, symbol, etc. Then, the image data read by the image reading section 30 is output to the image processing section 14.

The print section 40 performs image forming processing using electrophotography according to input print data and comprises a sheet feeding section, a fed sheet conveying section, an image forming section, an ejecting section and the like.

The sheet feeding section comprises a plurality of sheet feeding trays, a sheet feeding member, a manual sheet feeding tray and the like. The sheet feeding trays each store a sheet sorted in advance according to sheet type. The sheet feeding member conveys the sheet stored in the sheet feeding tray from the top one by one to the sheet conveying section. The manual sheet feeding tray can store various types of sheets to satisfy the user's needs. A sheet feeding roller conveys the sheet stored in the manual sheet feeding tray from the top one by one to the sheet conveying section.

The sheet conveying section conveys the sheet conveyed from the sheet feeding tray or the manual sheet feeding tray through a plurality of intermediate rollers, registration rollers, etc., and then to a transfer device. The sheet conveying section uses a conveying path switching board to convey the sheet with image forming processing performed on one face to the double-face conveying path and conveys the sheet through the intermediate rollers and registration rollers and then to the transfer device again.

The sheet forming section comprises a photoreceptor drum, a charging electrode device, a light exposing device including a laser output section for outputting a laser beam according to the image data and a polygon mirror for the laser beam to scan in a main scanning direction, a developing device, the transfer device, a cleaning section and a fusing device and realizes a function of forming an image on a sheet according to job information. Specifically, an electrostatic latent image is formed by focusing the laser beam with the light exposing device on the photoreceptor drum charged by the charging electrode device. The developing device deposits charged toner on the surface of the photoreceptor drum where the electrostatic latent image is formed and develops the electrostatic latent image. The toner image formed on the photoreceptor drum with the developing device is transferred onto the sheet with the transfer device. After the toner image is transferred onto the sheet, the residual toner, etc. on the surface of the photoreceptor drum is removed by the cleaning section.

The fusing device heat fuses the toner image transferred onto the sheet conveyed by the sheet conveying section. After the fusing processing is performed on the sheet, the sheet is nipped with a sheet ejection roller of the ejecting section and conveyed from the ejection opening to the finisher device.

The finisher device 50 comprises a finisher unit including a sorting section, punching section, stapling section, folding section, cutting section, etc., and sheet ejecting tray. The sorting section performs sorting processing of sheets with images formed. The punching section performs punching processing. The stapling section performs stapling processing to bind a stack of sheets at a set binding position. The folding section performs folding processing. The cutting section performs cutting processing. Sheets with an image formed by the print section 40 and sheets with various finisher processing performed are ejected and stored on the sheet ejecting tray.

When the image forming apparatus 1 is used as a network printer, the communication section 60 manages and controls a job input from an external apparatus (not shown) connected to the network N to the image forming apparatus 1. The communication section 60 receives data to be printed from the external device and sends the data as the job to the control section 10.

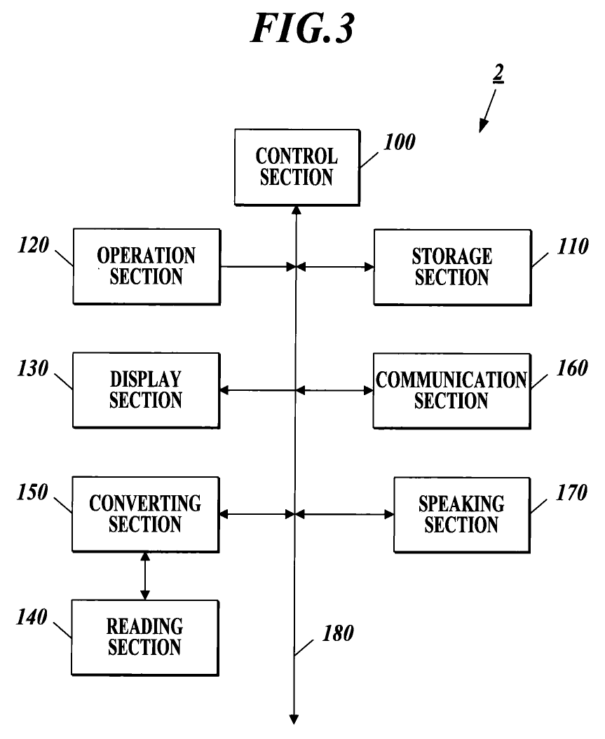

FIG. 3 shows a control block diagram of the terminal apparatus 2.

As shown in FIG. 3, the terminal apparatus 2 comprises a control section 100, storage section 110, operation section 120, display section 130, reading section 140, converting section 150, communication section 160 and speaking section 170 and the sections are connected to each other through a bus 180. The terminal apparatus 2 of the present embodiment is described with a cellular phone as an example.

The control section 100 is configured with a CPU, RAM, etc. and controls instruction to each section comprising the terminal apparatus 2, data communication between the sections, and the like. The control section 100 expands a specified program among a system program and various application programs stored in the storage section 110 in the RAM and the program expanded in the RAM and the CPU cooperate to perform various processing.

The control section 100 obtains an image code sending processing program of the present embodiment from the storage section 110, and in coordination with the program and various pieces of data, obtains code information based on the image code read by the reading section 140 and performs processing of sending the code information through the communication section 160 to the management server 3 to function as a sending control section.

The storage section 110 comprises, for example, an information readable recording medium such as a ROM, etc. and can further comprise an information readable and writable recording medium such as a flash memory, etc. The storage section 110 stores various programs such as e-mail software and Web browser program, various pieces of data and also an image code sending program.

The operation section 120 includes various keys such as arrow keys, numeric keypad, various operation keys, image code reading performing button, etc., and outputs an operation signal according to the various keys pressed by the user to the control section 100.

The display section 130 is configured with an LCD, Electro Luminescence Display (ELD), etc., and displays various pieces of information, photograph image, etc. of the terminal apparatus 2.

The reading section 140 is configured with an image sensor such as a Charge Coupled Device (CCD) or Complementary Metal Oxide Semiconductor (CMOS) sensor, etc., and functions as an image code reading section to expose to light and scan the image code displayed on the screen of the operation/display section 20 of the image forming apparatus 1 to optically read the image code and obtain image data of the image code.

The converting section 150 converts (decodes) the image code according to a predetermined encoding system. For example, when the converting section 150 detects a segmentation symbol peculiar to the image code in the image data read by the reading section 140, it is determined there is an image code, and the image code is extracted from the image data, the extracted image code is decoded according to the predetermined encoding system and the code information is obtained.

According to an instruction input from the control section 100, the communication section 160 performs wireless communication between a wireless base station which is not shown. For example, based on communication protocol of the terminal apparatus 2, the communication section 160 sends and receives sent and received voice audio and performs data communication to realize a function of performing communication with the management server. The communication section 160 can be a structure which communicates with external devices through a communication cable, etc.

The speaking section 170 is configured comprising a microphone, speaker, A/D conversion section, D/A conversion section and the like. The speaking section 170 performs A/D conversion of sent voice audio of the user input from the microphone in the A/D conversion section and outputs the voice audio as sent voice audio data to the control section 100. The speaking section 170 performs D/A conversion of audio data such as received voice audio data input from the control section 100, ring alert, operation confirmation sound, shutter sound in the D/A conversion section and the audio is output from the speaker.

Next, operation of the present embodiment will be described.

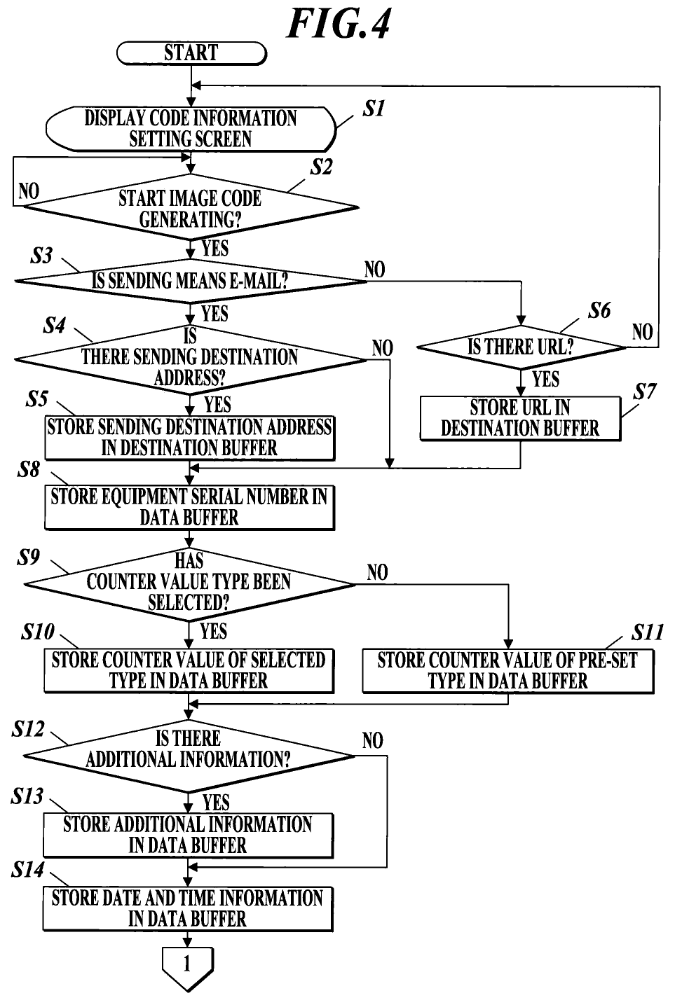

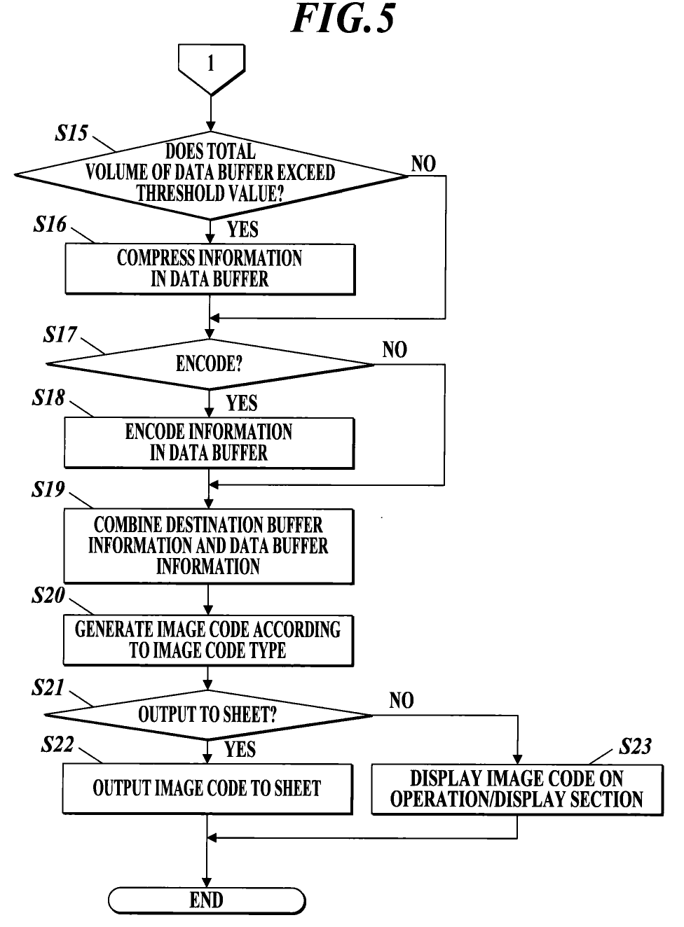

FIG. 4 and FIG. 5 are flowcharts showing an image code generating processing of the present embodiment. The control section 10 of the image forming apparatus 1 and the sections cooperate to perform the processing.

When an instruction of image code generating processing is received by the operation/display section 20, the control section 10 displays the code information setting screen on the LCD of the operation/display section 20 and receives setting of code information to generate image code (step S1).

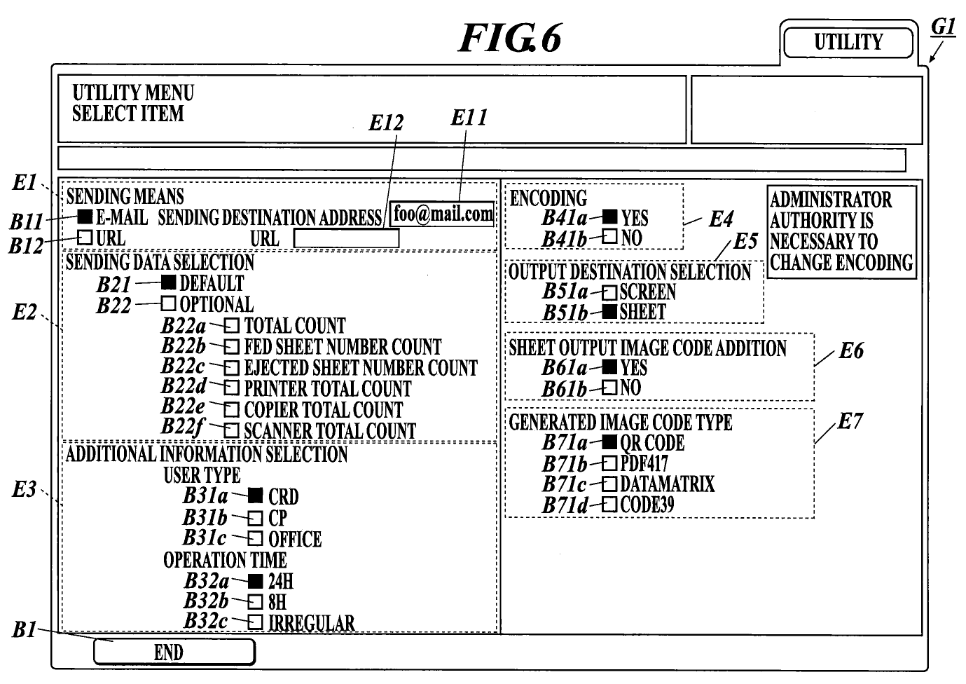

FIG. 6 shows an example of a code information setting screen G1.

As shown in FIG. 6, a sending means selection area E1, sending data selection area E2, additional information selection area E3, encoding selection area E4, output destination selection area E5, sheet output image code addition selection area E6, image code type selection area E7 and end button B1 are provided in the code information setting screen G1.

Information set in each area E1 to E7 are received as code information.

As means of sending a generated image code to a management server, a check box B11, address area E11, check box B12 and URL area E12 are provided in the sending means selection area E1. The check box B11 is for selecting e-mail. The address area E11 is an area for inputting address of sending destination of the e-mail. The check box B12 is for selecting a web page of the management server on the Internet. The URL area E12 is an area for inputting a URL of a web page.

A check box B21 and check box B22 are provided in the sending data selection area E2. The check box B21 is for selecting a predetermined type of counter value as a counter value to send to the management server. The check box B22 is for selecting any type of counter value.

When the check box B22 is selected, at least one of check boxes B22a to B22f provided as a type of counter value to send to the management server is selected. The check box B22a is for selecting total counter value. The check box B22b is for selecting fed sheet number counter value. The check box B22c is for selecting ejected sheet number counter value. The check box B22d is for selecting printer total counter value. The check box B22e is for selecting copier total counter value. The check box B22f is for selecting scanner total counter value.

Check boxes B31a to B31c and check boxes B32a to B32c are provided in the additional information selection area E3. The check box B31a to B31c are for selecting user type (for example, CRD, CP, office) who uses image forming apparatus 1 of the present embodiment. The check box B32a to B32c is for selecting operation time (for example, 24 hours, 8 hours, irregular, etc.).

Check boxes B41a and B41b for selecting whether or not to encode information code are provided in the encoding selection area E4 and either one or the other is selected.

Check boxes B51a and B51b are provided in the output destination selection area E5 and either one or the other is selected. The check box 51a is for selecting the screen of the LCD of the operation/display section 20 as the output destination of the generated image code. The check box B51b is for selecting forming an image based on the image code on a sheet by the print section 40.

Check boxes B61a and B61b for selecting whether or not to form on the sheet an image based on the generated image code are provided on the sheet output image code addition selection area E6 and either one or the other is selected.

Check boxes B71a to B71d for selecting type (for example, QR code, PDF 417, Data Matrix, Code 39, etc.) of image code to be generated are provided in the image code type selection area E7 and any one among a plurality of check boxes B71a to B71d is selected. Therefore, the image code type selection area E7 functions as a selection section to select one type among a plurality of types of image codes.

The control section 10 receives setting of code information by the code information setting screen G1 and judges whether or not an instruction to start image code generating is input (step S2). In judgment of step S2, when the end button B1 is pressed on the code information setting screen G1, the control section 10 judges the instruction to start image code generating is input.

When the instruction to start image code generating is not input (step S2; No), the control section 10 returns the processing to step S2. When the instruction to start image code generating is input, in other words, when the end button B1 is pressed (step S2; Yes), the control section 10 refers to information set on the code information setting screen and judges whether or not the sending means is e-mail, in other words, whether or not the check box B11 is selected (step S3).

When the sending means is e-mail, in other words, when the check box B11 is selected (step S3; Yes), the control section 10 judges whether or not an e-mail address as a sending destination address is input in the address area E11 (step S4).

When an e-mail address as a sending destination address is input in the address area E11 (step S4; Yes), the control section 10 stores the e-mail address (sending destination address) input in the address area E11 in the destination buffer in the RAM 12 (step S5).

When the e-mail address as a sending destination address is not input in the address area E11 (step S4; No), the control section 10 advances to the processing of step 8.

When the sending means is not e-mail, in other words, when the check box B12 is selected (step S3; No), the control section 10 judges the URL is selected as the sending means and judges whether or not the URL is input in the URL area E12 (step S6).

When the URL is input in the URL area E12 (step S6; Yes), the control section 10 stores the URL input in the URL area E12 in the destination buffer in the RAM 12 (step S7). When the URL is not input in the URL area E12 (step S6; No), the control section 10 returns to the processing of step S1.

After step S4; No, step S5, or step S7, the control section 10 stores a previously set equipment serial number in the data buffer in the RAM 12 as identification information to identify the image forming apparatus 1 of the present embodiment (step S8).

The control section 10 refers to the information set on the code information setting screen and judges whether or not there is an instruction to select type of counter value to be sent to the management server, in other words, whether or not the check box B21 is selected and at least one of the check boxes B22a to B22f is selected (step S9).

When there is an instruction to select type of counter value to be sent to the management server (step S9; Yes), the control section 10 reads out the counter value of the type corresponding to the check box selected among check boxes B22a to B22f from the HDD 13 and stores the read out counter value in the data buffer (step S10).

When there is no instruction to select type of counter value to be sent to the management server, in other words, when the check box B22 is selected (step S9; No), the control section 10 reads out a counter value of a type previously set from the HDD 13 and the read out counter value is stored in the data buffer (step S11).

After step S10 or step S11, the control section 10 refers to information set on the code information setting screen and judges whether or not there is information other than the counter value to be added (additional information), in other words, whether or not user type and/or operation time is selected in the additional information selection area E3 (step S12).

When there is additional information, in other words, when any one of check boxes B31a to B31c and/or any one of check boxes B32a to B32c is selected (step S12; Yes), the control section 10 stores the information corresponding to the selected check box in the data buffer as additional information (step S13).

When there is no additional information (step S12; No), or after step S13, the control section 10 stores in the data buffer date and time information of when the counter value was stored in the data buffer (step S14).

The control section 10 judges whether or not total volume of the information stored in the data buffer is larger than a previously set threshold value (exceed the threshold value) (step S15). When the total volume of the information stored in the data buffer exceeds the threshold value (step S15; Yes), the control section 10 performs compression processing on the information in the data buffer (step S16).

When the total volume of the information stored in the data buffer does not exceed the threshold value (step S15; No), or after step S16, the control section 10 refers to the information set on the code information setting screen and judges whether or not the setting of encoding is selected, in other words whether or not the check box B41a in the encoding selection area E4 is selected (step S17).

When the encoding setting is selected, in other words, when the check box B41a is selected (step S17; Yes), the control section 10 performs encoding processing on the information in the data buffer (step S18).

When the setting of encoding is not selected, in other words, when the check box B41b is selected (step S17; No), or after step S18, the control section 10 combines destination buffer information and data buffer information to generate code information (step S19).

The control section 10 refers to the information set on the code information setting screen and converts the code information combined and generated in step S19 to a type of image code corresponding to the check box selected in the image code type selection area E7 to generate the image code (step S20).

The control section 10 refers to the information set on the code information setting screen and judges whether or not an image based on the generated image code is output on a sheet, in other words, whether or not the check box B51b is selected in the output destination selection area E5 (step S21).

When the image based on the generated image code is output on a sheet, in other words, when the check box B51b is selected (step S21; Yes), the control section 10 refers to the information set on the code information setting screen and when the check box B61a is selected in the sheet output image code addition selection area E6, allows the print section 40 to form the image based on the image code on the sheet, and when the check box B61a is not selected, allows the print section to form the image of the code information shown by the image code on the sheet (step S22) and the processing ends.

When the image based on the generated image code is not output on the sheet, in other words, when the check box B51a is selected (step S21; No), the control section 10 displays the image based on the image code on the screen of the operation/display section 20 (step S23) and ends the processing.

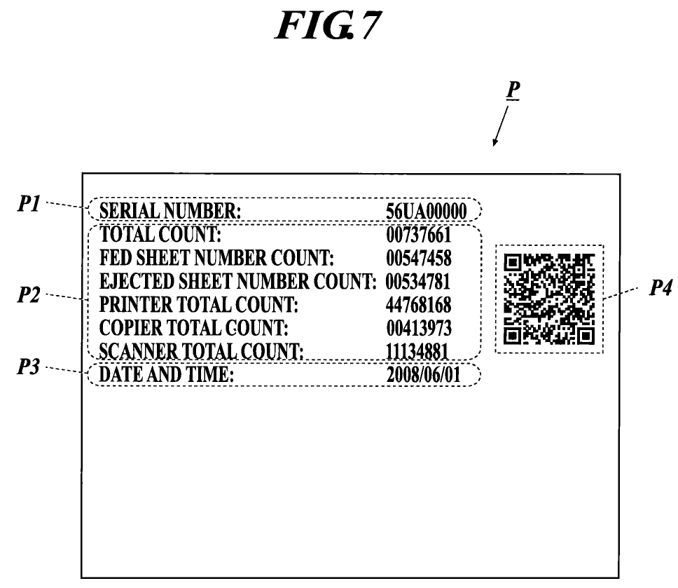

FIG. 7 shows an example of the sheet output from the print section 40 in step S22.

An equipment serial number P1, selected type counter value P2, date and time information P3 and image P4 based on the generated image code are formed on the sheet P shown in FIG. 7. Additional information other than the above-described information can be formed on the sheet. Therefore, the print section 40 including an image forming section functions as an image forming section for forming an image based on the image code on the sheet.

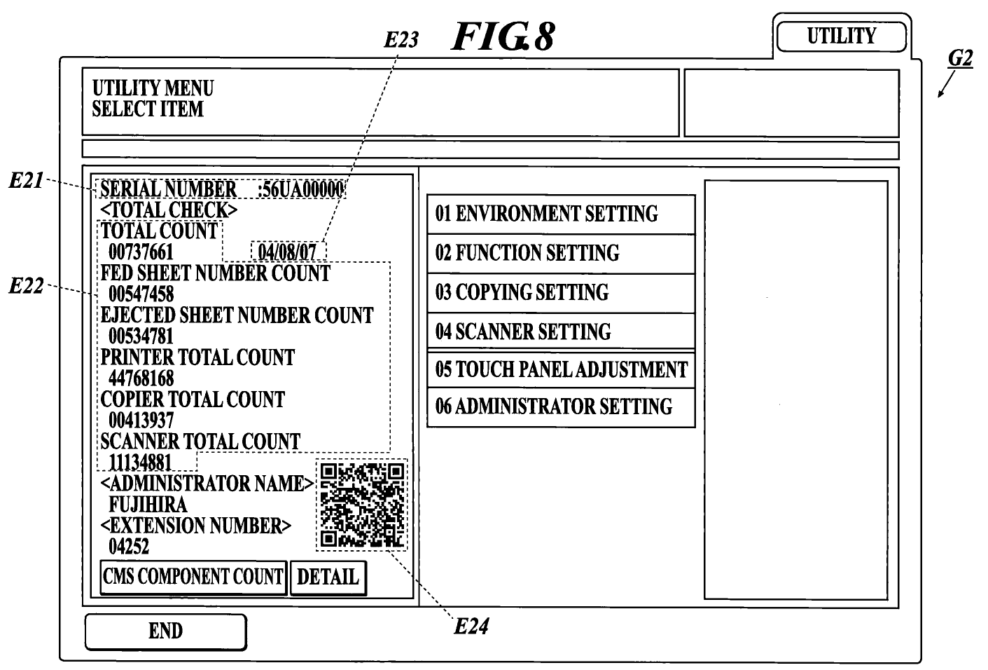

FIG. 8 shows an example of a screen displayed on the operation/display section 20 in step S23.

A serial number display area E21, counter value display area E22, date and time display area E23 and image code display area E24 are provided on the screen G2 shown in FIG. 8. The equipment serial number is displayed in the serial number display area E21. The counter value of the selected type is displayed in the counter value display area E22. The date and time information is displayed in the date and time display area E23. The image based on the generated image code is displayed in the image code display area E24. Additional information other than the above-described information can be displayed, and other code information included in the image code can be displayed by using character or symbol.

Therefore, the operation/display section 20 displaying the screen G2 as shown in FIG. 8 functions as a display section for displaying an image based on the image code.

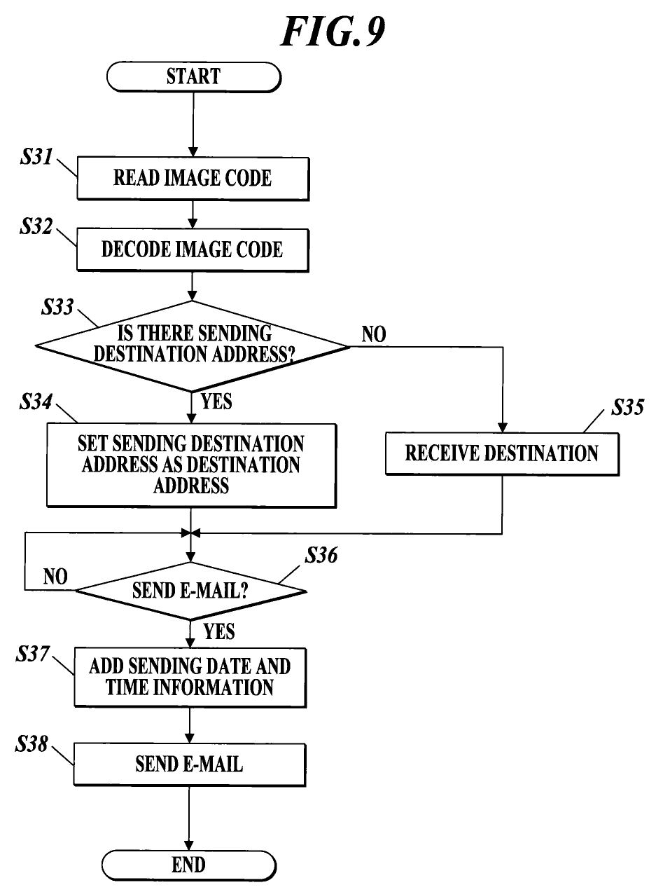

FIG. 9 shows a flowchart of image code sending processing. The control section 100 of the terminal apparatus 2 and the other sections cooperate to perform the processing.

When there is an input of instruction to send the image code by the operation section 120, the control section 100 allows the reading section 140 to read an image code displayed on the screen of the operation/display section 20 of the image forming apparatus 1 or the image code formed on the sheet output from the print section 40 and obtains image data of the image code (step S31).

The control section 100 allows the converting section 150 to decode the image data of the image code obtained by the reading section 140 to obtain code information (step S32).

When e-mail is selected as the sending means in the code information obtained in step S32, the control section 100 judges whether or not a sending destination address is included (step S33) and starts e-mail software.

When e-mail is not selected as the sending means, in other words, when URL is selected, the control section starts the web browser and connects to the web page input in the URL area to perform processing of sending the obtained code information to the web page and the processing ends.

When the sending destination address is included in the code information obtained in step S32 (step S33; Yes), the control section 100 sets the sending destination address as the destination address of the e-mail (step S34).

When the sending destination address is not included in the code information obtained in step S32 (step S33; No), the control section 100 receives input of the destination address of the e-mail from the operation section 120 (step S35). The user inputs the destination address of the e-mail by the operation section 120 in step S35.

After step S34 or step S35, in other words, after the destination address is set, the control section 100 sets code information other than the destination address as the message body data of the e-mail, and determines whether or not the instruction to send e-mail is input by the operation section 120 (step S36).

When the instruction to send e-mail is not input (step S36; No), the control section 100 returns the processing to step S36. When the instruction to send e-mail is input (step S36; Yes), the control section 100 adds sent date and time information to the e-mail including destination address and message body data (step S37) to allow the communication section 160 to send the e-mail (step S38) and ends the processing.

As described above, according to the present embodiment, the date and time information of when the counter value was obtained and the counter value can be converted together to the image code and output, therefore, it is clear when the counter value was obtained and the reliability of the counter value can be improved.

Further, the information in the data buffer including the counter value can be converted to the image code after encoding processing, therefore falsification of the counter value can be prevented, and reliability can be improved even more.

Also, the code information can be converted to the type of image code selected among a plurality of types of image codes, therefore, the code information can be converted to the image code of the type which can be displayed on the screen of the operation/display section 20 or which can be read by the terminal apparatus 2 after output on the sheet.

The equipment serial number for identifying the image forming apparatus which counted the counter value can be converted together with the counter value to the image code, therefore, source of the counter value is clear.

In the above description, disclosed are examples where the nonvolatile memory 11 or the storage section 110 is used as the computer readable medium of the program of the present invention, however the medium is not limited to these examples.

Other computer readable media which can be used include nonvolatile memory such as a flash memory, etc., or portable recording media such as a CD-ROM, etc.

Also, as media for providing data of the program of the present invention through a communication line, a carrier wave can be used in the present invention.

The present invention is not limited to the above-described embodiments and may be suitably modified within the scope of the present invention.

According to an aspect of the preferred embodiments of the present invention, there is provided an image forming apparatus, comprising:

an output section;

a counter to count operation record information;

a clock section to keep time for date and time information; and

a control section to obtain a counter value of operation record information counted by the counter, to obtain by the clock section date and time information of when the counter value is obtained, to generate code information including the counter value and the date and time information, to convert the code information to an image code, and to output the image code to the output section.

According to another aspect of the preferred embodiments of the present invention, there is provided a management system of an image forming apparatus comprising:

an image forming apparatus; and

a terminal apparatus to send information concerning the image forming apparatus to a management server, wherein

the image forming apparatus comprises:

an output section;

a counter to count operation record information;

a clock section to keep time for date and time information; and

a control section to obtain a counter value of the operation record information counted by the counter, to obtain by the clock section the date and time information of when the counter value is obtained, to generate code information including the counter value and the date and time information, to convert the code information to an image code, and to output the image code to the output section, and

the terminal apparatus comprises:

a communication section to perform communication with the management server;

an image code reading section to read the image code; and

a sending control section to obtain the code information based on the image code read by the image code reading section to send the code information through the communication section to the management server.

According to another aspect of the preferred embodiments of the present invention, there is provided a management method of sending information of an image forming apparatus to a management server, the method comprising:

obtaining a counter value counted by a counter which counts operation record information of the image forming apparatus;

obtaining by a clock section date and time information of when the counter value is obtained;

generating code information including the counter value and the date and time information of when the counter value is obtained;

converting the code information to an image code;

outputting the image code to the output section;

reading the image code output from the output section;

obtaining the code information based on the read image code; and

sending the code information through a communication section to the management server.

The image forming apparatus, management system and management method can convert the date and time information of when the counter value was obtained together with the counter value to the image code and output the image code, therefore, it is clear when the counter value was obtained and the reliability of the counter value can be improved.

Preferably, the control section converts the code information to the image code after performing encoding processing on the counter value.

The counter value after encoding processing can be converted to the image code, therefore falsification of the counter value can be prevented and reliability is improved even more.

Preferably, the preferred embodiments further comprise a selection section to select any one type among a plurality of types of image codes, wherein

the control section converts the code information to the type of image code selected by the selection section.

The code information including the counter value can be converted to a type of image code selected among a plurality of types of image codes, therefore, the code information can be converted to the type of image code which can be used after output from the output section.

Preferably, the output section is a display section to display an image based on the image code or an image forming section to form the image based on the image code on a sheet.

The image based on the image code can be output by displaying on the display section or forming on the sheet.

Preferably, the output section displays on a same screen or forms on a same sheet the image based on the image code and the counter value of the operation record information.

Preferably, the preferred embodiments further comprise:

a display section to display an image based on the image code and an image forming section to form the image based on the image code on a sheet as output sections; and

an output destination selection section to select at least one between the display section and the image forming section as an output destination of the image based on the image code.

Preferably, the image code is represented by a QR code or barcode.

Preferably, the code information includes identification information to identify the image forming apparatus.

The identification information for identifying the image forming apparatus which counted the counter value can be converted together with the counter value to the image code, therefore the source of the counter value can be clear.

Preferably, the code information includes information concerning sending method when the operation record information is sent.

Preferably, the code information includes address information of a sending destination to where the operation record information is sent; and

the sending control section extracts address information of the sending destination from the code information and sends the code information to the destination of the extracted address information.

Preferably, the sending control section sends the code information including the counter value of the operation record information and the date and time information of when the counter value is obtained, and date and time information of when the information is sent to the management server.

The present U.S. patent application claims priority under the Paris Convention of Japanese Patent Application No. 2008-161136 filed on Jun. 20, 2008 to the Japanese Patent Office, which shall be a basis for correcting mistranslations.

What is claimed is:

1. An image forming apparatus, comprising:
an output section;
a counter to count operation record information;
a clock section to keep time for date and time information; and
a control section to obtain a counter value of operation record information counted by the counter, to obtain by the clock section date and time information of when the counter value is obtained, to generate code information including the counter value and the date and time information, to convert the code information to an image code, and to output the image code to the output section.

2. The image forming apparatus of claim 1, wherein the control section converts the code information to the image code after performing encoding processing on the counter value.

3. The image forming apparatus of claim 1, further comprising a selection section to select any one type among a plurality of types of image codes, wherein
the control section converts the code information to the type of image code selected by the selection section.

4. The image forming apparatus of claim 1, wherein the output section is a display section to display an image based on the image code or an image forming section to form the image based on the image code on a sheet.

5. The image forming apparatus of claim 4, wherein the output section displays on a same screen or forms on a same sheet the image based on the image code and the counter value of the operation record information.

6. The image forming apparatus of claim 1, further comprising:
a display section to display an image based on the image code and an image forming section to form the image based on the image code on a sheet as output sections; and
an output destination selection section to select at least one between the display section and the image forming section as an output destination of the image based on the image code.

7. The image forming apparatus of claim 1, wherein the image code is represented by a QR code or barcode.

8. The image forming apparatus of claim 1, wherein the code information includes identification information to identify the image forming apparatus.

9. The image forming apparatus of claim 1, wherein the code information includes information concerning sending method when the operation record information is sent.

10. A management system of an image forming apparatus comprising:
an image forming apparatus; and
a terminal apparatus to send information concerning the image forming apparatus to a management server, wherein
the image forming apparatus comprises:
an output section;
a counter to count operation record information;
a clock section to keep time for date and time information; and
a control section to obtain a counter value of the operation record information counted by the counter, to obtain by the clock section the date and time information of when the counter value is obtained, to generate code information including the counter value and the date and time information, to convert the code information to an image code, and to output the image code to the output section, and
the terminal apparatus comprises:
a communication section to perform communication with the management server;
an image code reading section to read the image code; and
a sending control section to obtain the code information based on the image code read by the image code reading section to send the code information through the communication section to the management server.

11. The management system of claim 10, wherein the control section converts the code information to the image code after performing encoding processing on the counter value.

12. The management system of claim 10, further comprising a selection section to select any one type among a plurality of types of image codes, wherein
the control section converts the code information to the type of image code selected by the selection section.

13. The management system of claim 10, wherein the output section is a display section to display an image based on the image code or an image forming section to form the image based on the image code on a sheet.

14. The management system of claim 10, wherein the code information includes identification information to identify the image forming apparatus.

15. The management system of claim 10, wherein
the code information includes address information of a sending destination to where the operation record information is sent; and
the sending control section extracts address information of the sending destination from the code information and sends the code information to the destination of the extracted address information.

16. The management system of claim 10, wherein the sending control section sends the code information including the counter value of the operation record information and the date and time information of when the counter value is obtained, and date and time information of when the information is sent to the management server.

17. A management method of sending information of an image forming apparatus to a management server, the method comprising:
obtaining a counter value counted by a counter which counts operation record information of the image forming apparatus;
obtaining by a clock section date and time information of when the counter value is obtained;
generating code information including the counter value and the date and time information of when the counter value is obtained;
converting the code information to an image code;
outputting the image code to the output section;
reading the image code output from the output section;
obtaining the code information based on the read image code; and
sending the code information through a communication section to the management server.
